(19) United States
(12) Patent Application Publication
(10) Pub. No.: US 2005/0137957 A1
(43) Pub. Date: Jun. 23, 2005

(54) Investment vehicle secured by government assets and electronic trading system for same

(76) Inventor: James Mark McDaniel JR., Greensboro, NC (US)

Correspondence Address: Karl G. Schwappach;Faegre & Benson LLP, 2200 Wells Fargo Center, 90 South Seventh Street, Minneapolis, MN, 55402-3901, US

(21) Appl. No.: 10/745,268

(22) Filed: Dec. 23, 2003

(51) Int. Cl. G06F 17/60

(52) U.S. Cl. 705/37; 705/40; 705/35

(57) ABSTRACT

A computer system trades investment vehicles secured by governmental assets via a computerized network. A computer server is accessible with a network access device via a communications network. Executable software stored on the server is executed to transmit data relating to trading investment vehicles secured by governmental assets; to receive an instruction to buy or sell an investment vehicle secured by governmental assets; and to transmit a live order from an investor, wherein the live order is related to the instruction to buy or sell an investment vehicle secured by governmental assets. A database of investment vehicle profiles is maintained that includes a term, a face value, a governmental guarantee to repay the face value at the end of the term, a payment schedule requiring periodic payments by the governmental entity comprising a percentage of the face value, and an allocation of appreciation of the pool of governmental assets during the term of the investment vehicle. The computer communications system can be a private network or the Internet.

### FIELD OF THE INVENTION

The present invention relates to an automated method and system for trading investment vehicles secured by governmental assets, and to investment vehicles that use the investment potential of government assets while simultaneously lowering the cost to the government for use of that government asset and freeing cash equity for governmental use for services and/or debt retirement.

### BACKGROUND OF THE INVENTION

Federal, state, and local governments face fiscal pressures to provide services that the public demands with the revenue that it collects through taxes, usage fees and the like. In times of economic downturn, many government entities face severe budget issues, which require the entity to make difficult choices regarding funding, taxation, and deficits. For example, the United States Commerce Department reported that state and local governments borrowed $127 billion more than they repaid in 2002. In fact, borrowed money equaled 9.7% of state and local expenditures in 2002. Debt service on this borrowed money has become an increasingly large portion of governmental expenditures, further starving governmental entities of the cash needed to provide services.

Meanwhile governments at all levels have billions of dollars tied up in a variety of assets, such as real estate and other property. Government-owned buildings, which typically house governmental offices, built or purchased at taxpayer expense, represent large pieces of public equity that is presently not available to governmental entities.

Private sector businesses that own commercial real estate will often use the property to secure loans or to sell bonds. Alternatively, the property can be sold and immediately leased from the new owner in a “sale and lease-back” transaction. A sale and lease-back transaction allows the business to access the capital previously tied up in the asset. The lease payments made to the new property owner are deducted as a legitimate operating expense for income tax purposes. The sale and lease-back transaction provides potential investors with a stable income return on the property as a result of the lease payments, as well as a speculative return based on the potential appreciation of the property.

A well-known type of organization authorized by United States federal law, known as a Real Estate Investment Trust (“REIT”), invests specifically in commercial real estate. While a REIT may invest in any type of commercial real estate properties or debt instruments, including multi-family housing, shopping centers, and office buildings, it may also engage in sale and lease-back arrangements. Congress has created specific regulations regarding the distribution of profits for REITs, requiring, for example, that they distribute all taxable income to investors in the form of dividends.

REITs have been successful because they have three distinct advantages over traditional ownership vehicles for commercial property. First, interests in REITs can be publicly traded, increasing the liquidity of commercial real estate. Second, the value of a REIT is based on the underlying assets it owns, and hence, is typically not as volatile as other types of investments, such as equity instruments in operating companies. Third, REITs are a pass-through entity for income tax purposes and thus avoid potential double taxation.

Such strategies have been proposed for foreign governments that own businesses that are scheduled for privatization. In one version of this scenario, an investor purchases an asset, such as a building from the foreign government, and leases it back to the foreign government. As proposed, the lease would not be backed by any governmental guarantee. If the government defaults on the lease, the private entity would retain title to the property, but would lose the stream of lease payments that would have been due under the lease. Also, bringing an action against a government tenant for default of a lease can be problematic, especially in some foreign countries. In addition, the purpose of this investment strategy is to maximize the rental income for the owners. It is known that investment in countries with fledgling free-market economies entails a great deal of risk. As such, rental amounts are adjusted to reflect the risk of default. In such a scenario, the lease payments would likely be proportional to the investment grade of bonds issued by such governmental entity. Consequently, such a sale and lease-back scheme would likely be the same as, or even less financially attractive than, conventional debt instruments.

Complicating government's task of raising capital are the complexities of the securities market, where the securities each have distinctive characteristics based on the issuing governmental entity, as well as the credit rating, coupon, maturity, payment schedule or other characteristics.

### BRIEF SUMMARY OF THE INVENTION

The present invention provides a computer-implemented method for providing investment vehicles secured by governmental assets via a communications network such as the Internet. In one embodiment, data relating to trading an investment vehicle secured by governmental assets is exchanged through the trading system. A live order, based upon the sale information received, can then be executed or transmitted to a point of execution. In another embodiment, the live order provides that the trading system acts as counter-party to each transaction such that a client investor can remain anonymous to a party on the other side of a trade. In this manner, a first trade can be executed between a party selling the investment vehicles secured by governmental assets and the trading system, and a second trade can be executed between the trading system and a party purchasing the investment vehicles secured by governmental assets. Numerous types of investment vehicles secured by governmental assets can be traded, as well as corporate bonds, municipal bonds and the like.

The computer system trades investment vehicles secured by governmental assets via a computerized network. A computer server is accessible with a network access device via a communications network. Executable software stored on the server is executed to transmit data relating to trading investment vehicles secured by governmental assets; to receive an instruction to buy or sell an investment vehicle secured by governmental assets; and to transmit a live order from an investor, wherein the live order is related to the instruction to buy or sell an investment vehicle secured by governmental assets. A database of investment vehicle profiles is maintained that includes a term, a face value, a governmental guarantee to repay the face value at the end of the term, a payment schedule requiring periodic payments by the governmental entity comprising a percentage of the face value, and an allocation of appreciation of the pool of governmental assets during the term of the investment vehicle. The computer communications system can be a private network or the Internet.

The present invention is also directed to a method of trading investment vehicles secured by governmental assets via a computerized network. The method includes establishing a computer server accessible with a network access device via a communications network. Software stored on the server is executed. Data relating to trading investment vehicles secured by governmental assets is transmitted. Instructions to buy or sell an investment vehicle secured by governmental assets is received. A live order is transmitted from an investor, wherein the live order is related to the instruction to buy or sell an investment vehicle secured by governmental assets. A database of investment vehicle profiles is maintained. The database includes a term, a face value, a governmental guarantee to repay the face value at the end of the term, a payment schedule requiring periodic payments by the governmental entity comprising a percentage of the face value, and an allocation of appreciation of the pool of governmental assets during the term of the investment vehicle.

The present invention is also directed to an investment vehicle secured by governmental assets. One or more governmental assets are arranged into a pool of governmental assets. The investment vehicle is secured by the pool of governmental assets. The investment vehicle includes a term; a face value that is less than, or equal to, an appraised value of the pool of governmental assets; a governmental guarantee to repay the face value at the end of the term; a payment schedule requiring periodic payments by the governmental entity comprising a percentage of the face value; and an allocation of appreciation of the pool of governmental assets during the term of the investment vehicle.

The allocation of appreciation of the pool of governmental assets can be a maximum percentage of the appreciation or a maximum percentage of the face value. The periodic payments are preferably tax-free interest payments. In one embodiment, the investment vehicle comprises a plurality of zero coupon bonds with maturity dates and face values that correspond to the periodic payments. In another embodiment, the investment vehicle comprises a plurality of coupon bonds, wherein the coupons have maturity dates and face values that correspond to the periodic payments. The periodic payments are preferably less than debt service on a conventional government security yielding the face value of the investment vehicles secured by governmental assets.

The system preferably includes a private entity that purchases the investment vehicles secured by governmental assets. The private entity then issues equity instruments to investors that contribute funds to the private entity.

In another embodiment, the present investment vehicles secured by governmental assets includes a sales document transferring title of a governmental asset to a private entity in exchange for funds. The transfer of title converts the governmental asset into a private asset. An investment vehicle comprising a general obligation lease between the private entity and the governmental entity grants the governmental entity usage of at least a portion of the private asset in exchange for periodic payments.

The periodic payments can be one or more of lease payments, interest payments, or a combination thereof. The investment vehicle preferably pledges the full faith and credit of the governmental entity to make periodic payments to the private entity. The general obligation lease permits the private entity to transfer all or part of its rights in the private asset to a third party. The periodic payments are preferably determined by the interest rate costs of the funds instead of the fair market value of the governmental asset. Consequently, the periodic payments under the lease are typically less than debt service on a conventional government security yielding the same amount of funds obtained through the sale of the governmental asset.

The funds can be greater than or less than the fair market value of the governmental asset. A tax abatement is preferably granted on the private asset during a term of the general obligation lease.

The private entity typically issues at least one class of equity instruments to investors that contribute funds to the private entity. The investors receive a portion of any appreciation of the private asset at the end of the lease. In one embodiment, a portion of the funds used to purchase the governmental asset are derived from granting a mortgage in the private asset to a lender.

The governmental entity may have an ownership stake in the private entity. In one embodiment, the governmental entity has a controlling interest in the private entity. For example, the private entity comprises a partnership and the governmental entity is a general partner, while the private investors are limited partners.

The present invention is also directed to a method of operating an investment vehicle secured by governmental assets. One or more governmental assets are pooled. The value of the pool of governmental assets is determined by an appraisal. A term is established for the investment vehicle. A face value that is less than, or equal to, an appraised value of the pool of governmental assets is also established for the investment vehicle. Funds are received from the investor corresponding to the face value of the investment vehicle. The investment vehicle secured by the pool of governmental assets is issued to at least one investor. The governmental guarantee to repay to the investor the face value at the end of the term is provided. A payment schedule of periodic payments by the governmental entity to the investor comprising a percentage of the face value is established. At least a portion of appreciation of the pool of governmental assets during the term of the investment vehicle is allocated to the investors.

The step of allocating the appreciation of the pool of governmental assets includes establishing a maximum percentage of the appreciation or a maximum percentage of the face value.

In another embodiment of the present method, title of a governmental asset is transferred to a private entity in exchange for funds. The transfer of title converting the governmental asset into a private asset. An investment vehicle comprising a general obligation lease between the private entity and the governmental entity is issued. The general obligation lease grants the governmental entity usage of at least a portion of the private asset in exchange for periodic payments.

In an alternate embodiment, the private entity may be a partnership in which the governmental entity and one or more investors are partners. In this embodiment, the governmental entity may have a controlling partnership interest, and the one or more investors may invest in the remaining interest of the partnership. In a particular embodiment, the partnership is a limited partnership, in which the government entity is a general partner and each of the one or more investors are limited partners. Optionally, each investor's interest in the private asset may be limited to a predetermined percentage of that investor's initial investment in the partnership.

In another embodiment, appreciation of the private asset can be allocated equally or unequally between the general partners and the limited partners. When the general obligation lease expires, appreciation on the private asset can be distributed to the owners of the private entity. In one embodiment, the portion of appreciation distributed to limited partners can be capped at some predetermined level. The balance of the appreciation is retained by the general partners. For example, in an embodiment where the government entity is the sole general partner, the government entity would participate in the appreciation to a greater extent than the limited partners.

### BRIEF DESCRIPTION OF THE SEVERAL VIEWS OF THE DRAWING

FIG. 1 is a schematic illustration of a trading system for the present investment vehicles secured by governmental assets in accordance with the present invention.

FIG. 2 is a more detailed illustration of the communications network of FIG. 1.

FIG. 3 is a schematic illustration of the present sale and lease-back system for governmental assets.

FIG. 4 is a schematic illustration of an alternate embodiment of the present sale and lease-back system for governmental assets.

FIG. 5 illustrates a printout of the expected results of a series of exemplary sale and lease-back agreements for governmental assets.

### DETAILED DESCRIPTION OF THE INVENTION

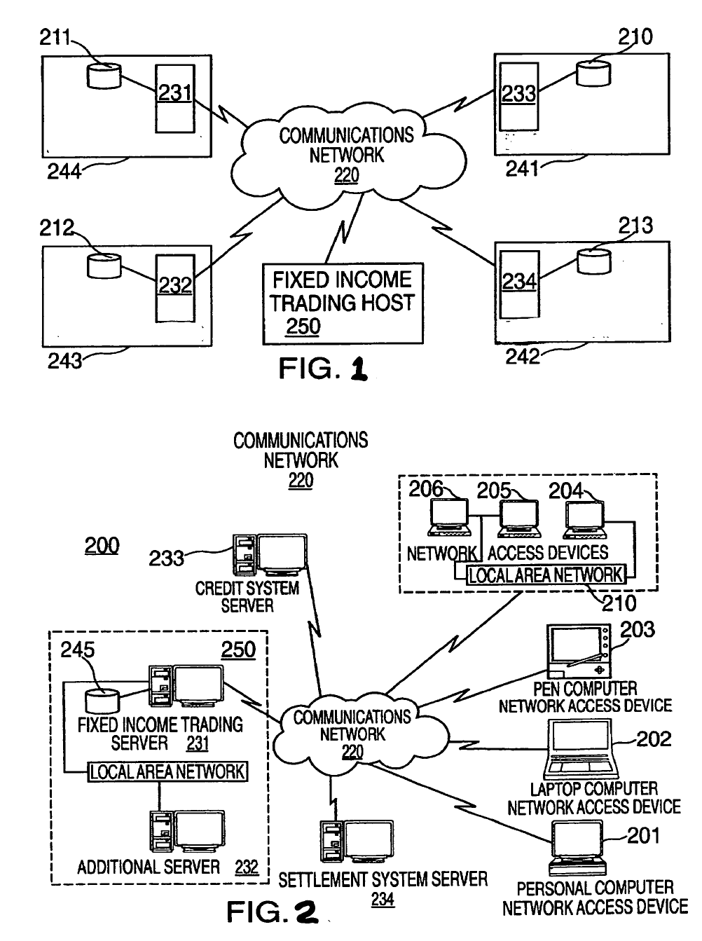

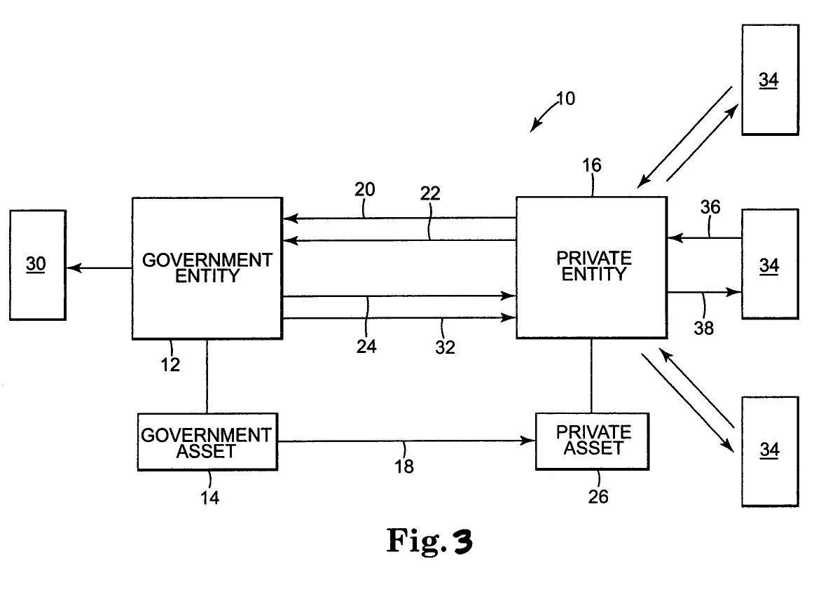

As illustrated in FIGS. 1 and 2, the present invention relates to a method and system that enables direct trading between market participants of the present investment vehicles secured by governmental assets. Market participants such as institutional investors, broker dealers and others can transact directly for the purpose of trading the present investment vehicles secured by governmental assets, as well as other investment grade, high yield corporate bonds, municipal bonds or other securities. A financial institution providing a trading system can act as a counter-party to all transactions, from trade execution through settlement, and has the option to serve as a credit intermediary. The market participants are able to maintain anonymity with regard to each other. The system provides price transparency and enhanced liquidity. Computer systems are utilized in conjunction with an electronic communications network to facilitate live execution of matched bids and offers. Software routines can direct an investor to various investment vehicles secured by governmental assets available according to specific criteria put forth by the investor.

A computer communications network is utilized to provide a vehicle for participation. An investor can use a network access device, such as a computer, to view bond auction offerings and/or market related information and present bids in a timely manner to available offerings over the network.

Referring now to FIG. 1, an online trading system can include a trading host 250 accessible via a distributed network 220 such as the Internet, or a private network. Investor locations 241-244 can use a computerized system or network access device 231-234 to receive and view information regarding investment vehicles secured by governmental assets and to transmit bids to the host 250.

FIG. 2 shows a network of computers 200 that may be used in an implementation of an online trading system. The network 200 can include a host system 250 and network access devices 201-206. Each of the network access devices includes a processor, memory and a user input device, such as a keyboard and/or mouse, and a user output device, such as a display screen and/or printer. The network access devices 201-206 can communicate with the host 250 to obtain trading data stored at the host 250. The network access device 201-206 may interact with the host computer 250 as if the host was a single entity in the network 200. However, the host 250 may include multiple processing and database sub-systems, such as cooperative or redundant processing and/or database servers 231-232, that can be geographically dispersed throughout the network 200. In some implementations, groups of network access devices 204-206 may communicate with host 250 through a local area network 210.

The host computer 250 includes one or more databases 245 storing data relating to trading and profiles of the available investment vehicles. The database can include for example, price, quantity, maturity date, a summary of the governmental assets used to secure the investment vehicles, the level of participation in the appreciation of the governmental asset at the end of the term of the investment vehicle, the credit worthiness of the governmental entity, and any other information pertaining to the trading activities. The host 250 may interact with and/or gather data from an investor who is operating a network access device 201-206. Data gathered from the investor may be used to conduct trading or provide information to the investor.

Typically an investor will access the host 250 using client software executed at the investor's network access device 201-206. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from the host 250 to the client computer and executed at the client computer as part of the live auction software. Other implementations include proprietary software installed from a computer readable medium, such as a CD ROM. The invention may therefore be implemented in digital electronic circuitry, computer hardware, firmware, software, or in combinations of the above.

Interaction with the trading host can provide real time display of live orders. Order entry can be accomplished by spread, real time U.S. treasury price, or price on yield. The host 250 will effect automated matching of orders and provide full book display for all issues with markets. In addition, a trade and order history can be made available via a library.

The trading system operates in real time and thereby has the ability to post trades as they are consummated. If desired, the trade information can then be immediately forwarded to interested parties for confirmation and record keeping. Summary reports can also be compiled and distributed at predetermined time intervals, or upon request. Additional services, such as trade settlement and credit verification can be provided over the network 220 via servers such as a settlement server 234 or a credit system server 233.

Numerous variations of the present network 220 are possible, such as illustrated in H2064 and U.S. Pat. No. 6,408,282, both of which are incorporated by reference.

First Embodiment of the Present Investment Vehicles Secured by Governmental Assets

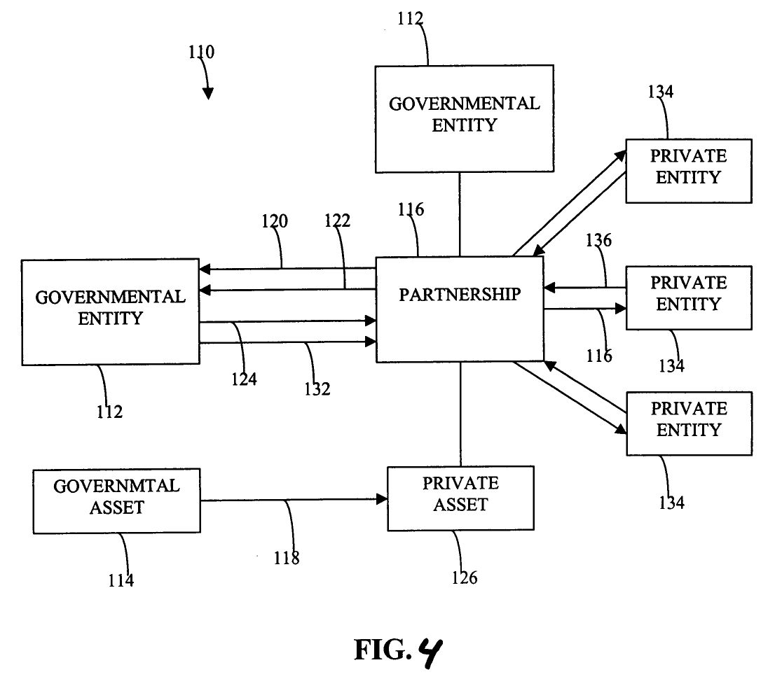

FIG. 3 illustrates a first embodiment of an investment vehicle secured by governmental assets 10 in accordance with the present invention. Governmental entity 12 sells all or a portion of a governmental asset 14 to a private entity 16. Title 18 to the governmental asset 14 transfers to the private entity 16. The governmental asset 14 is converted to a private asset 26 owned by the private entity 16. In exchange for transferring title 18 in the governmental asset 14, the governmental entity 12 receives funds 20 from the private entity 16. The governmental entity 12 is then free to use the funds 20 for normal government expenditures 30.

As part of the overall transaction, an investment vehicle between the governmental entity 12 and the private entity 16 is created. In the illustrated embodiment, the investment vehicle is a lease 22 that provides the governmental entity 12 usage of at least a portion of the private asset 26 in exchange for periodic payments 24. The periodic payments 24 can be characterized as lease payments, interest payments, or a combination thereof.

As will be discussed below, the lease 22 is preferably a general obligation lease in which the governmental entity pledges its full taxing and borrowing powers to performance under the lease 22. In another embodiment discussed below, the governmental entity 12 retains title to the governmental asset 14, but uses the governmental asset 14 to secure the investment made by the private entity 16.

As used herein, “governmental entity” refers to federal, state or local governmental bodies having tax and spend authority, including without limitation cities, counties, airport authorities, port authorities, and economic development authorities. The term “governmental asset” refers to one or more tangible assets, including without limitation developed or undeveloped land, buildings and other structures, equipment, and infrastructure such as roads, bridges, airports, rights-of-way, and the like, or any portion thereof, owned by a governmental entity. In one embodiment, a plurality of governmental assets are pooled together to form the governmental asset. The term “private asset” refers to a former governmental asset that is now owned by one or more private entities.

The terms of the lease 22 depend, at least in part, on the nature of the private asset 26. The lease 22 will typically be for a term of years, but alternatively, it could be a periodic tenancy or a tenancy at will. During the term of the lease 22, the governmental entity 12 will have a right to use, possess, and enjoy the private asset 26 as defined in the terms of the lease 22. At the end of the lease 22 the private entity 16 will have the right to enter into another lease arrangement with the same or a different governmental entity 12, or utilize the private asset 26 in any manner that it chooses, consistent with the applicable rights and obligations of property ownership, including selling the private asset 26. The lease can optionally include a purchase option that permits the governmental entity to repurchase the private asset 26 at a stated price or the fair market value.

The funds 20 paid by the private entity 16 to the governmental entity 12 will typically be the fair market value of the governmental asset 14. In another embodiment, the funds 20 are less than the fair market value of the governmental asset 14 in exchange for decreased lease payments 24 over the life of the lease 22. In another embodiment, the funds 20 are more than the fair market value of the governmental asset 14 in exchange for increased lease payments or the private entity 16 receiving preferential tax treatment, as will be discussed below.

The private entity 16 is preferably one or more investment entities created specifically to purchase governmental asset 14 and enter into lease-back arrangements with the governmental entity 12 from which it purchased the property. The “private entity” may be any authorized organization, such as a corporation, partnership, limited liability corporation, trust, real estate investment trust (REIT), and the like. Furthermore, the governmental entity 12 may purchase or otherwise receive a partial ownership interest in the private entity 16. Typically, a REIT may be a corporation or a partnership. While a REIT is a preferred private entity to enter into such sale and lease-back arrangements with the government, it is to be understood that the private entity may be any suitable entity.

The private entity 16 has two potential avenues for a return on its investment. First, the lease payments 24 provide a revenue stream over the life of the lease 22 (or the present value of that revenue stream, should the private entity 16 decide to sell that interest). Second, any appreciation that the governmental asset 14 may realize would be the property of the private entity 16. The private entity 16 also has the right to sell some or all of its interest in the private asset 26 and/or the lease 22 to a third party, subject to the rights granted to the governmental entity 12 in the lease 22.

These sources of return should attract investors 34, which supply capital 36 to the private entity 16. The investors 34 can be individuals, other private entities 16, or one or more governmental entities 12. In return, the private entity 16 sells ownership interests or issues equity instruments 38 to the investors 34. These equity instruments 38 may be bonds, ownership shares, membership in a partnership, or any other suitable equity interest. The equity instruments 38 of the private entity 16 can preferably be publicly or privately traded.

Some embodiments of the present investment vehicles secured by governmental assets 10 contemplate different classes of investors 34. For example, the investors 34 can be a mix of general and limited partners. The equity instruments 38 issued by the private entity 18 can be a mix of preferred and common shares. Consequently, the rights of the investors 34 to participate in the proceeds from the transaction can vary. For example, all investors 34 may participate in the lease revenue in proportion to their respective investments, while certain classes of investors participate preferentially in appreciation of the private asset 26. Similar results may be achieved through terms related to shareholder voting.

In another embodiment, the private entity 16 obtains a portion of the funds 20 needed to purchase the government asset 14 using conventional equity financing. For example, the private entity 16 obtains a mortgage from one or more lenders. The mortgage funds are combined with funds 36 from the investors 34 to purchase the governmental asset 14. A portion of the lease payments 24 are used to service the mortgage. The percentage of financing obtained from the lender and the investors 34 can vary depending upon the nature of the governmental asset 14 and a variety of other factors. The term of the mortgage is preferably the same as the term of the lease 22.

One advantage of including an equity financing component in the present investment vehicles secured by governmental assets 10 is that a portion of the equity in the private asset 26 is retained by the lenders during the term of the mortgage. At the expiration of the lease 22, that equity can be used to upgrade the private asset 26 for use by other tenants or in preparation for resale. For example, the lenders may hold a mortgage for 40% of the value of the private asset 26, while the investors 34 own the other 60%. The mortgage is preferably paid-off at the end of the lease 22. Consequently, approximately 40% of the equity of the private asset 26 is available to finance remodeling or other improvements.

In one embodiment, the governmental asset 14 is a building in which the governmental entity 12 may only require a portion of the space. The lease 22 can be written to cover only a portion of the building, while the private entity 16, as owner of the building, is free to dispose of the unused space in the open market.

In another embodiment, the governmental asset 14 is land on which a governmental building is situated. The governmental entity 12 sells the land to the private entity 16 in exchange for funds 20. The private entity 16 enters into an extended lease 22 for the land with the governmental entity 12 in exchange for lease payments 24. The governmental entity 12 retains title to the building, but not the underlying land. At the end of the lease 22, title to the building automatically transfers to the private entity 16.

Minimizing Governmental Payments in Sale and Lease-Back Arrangements

When an investor engages in a conventional sale and lease-back arrangement with a private corporation, the investor assumes a risk that the corporation will default on the lease. In the event of default, the investor retains title to the property, but loses any future lease payments and may incur significant costs to find another tenant. Therefore, the investor will factor in the risk of default when determining the level of lease payment required to make the investment worthwhile. The greater the risk, the higher the lease payments the corporation will have to pay.

In a conventional sale and lease-back arrangement, in order to attract investors the governmental entity 12 would have to make a lease payment 24 on the lease 22 comparable to that paid by corporations with a high-grade bond ratings. Unfortunately, such lease rates are typically higher than what a governmental entity might pay as interest on conventional governmental bonds. Thus, the governmental entity will likely pay a premium for the capital it raised by a sale and lease-back arrangement in excess of the cost of raising capital by issuing a debt instrument, such as a bond. Therefore, there is little financial incentive for governmental entities to utilize a conventional sale and lease-back arrangement.

Conversely, if the market rate for sale and lease-back arrangements with corporations having high grade bond ratings creates a higher lease rate than what the governmental entity is willing to pay, investors may not be attracted to private entities 16 attempting to engage in a sale and lease-back transaction. What is needed, then, is a method by which the governmental entity 12 can attract investors to participate in the investment vehicles secured by governmental assets 10, while allowing the governmental entity 12 to pay the lowest lease rate that will attract investors.

State and local governments as well as the United States Government have long used their “full faith and credit” to back financial instruments, such as general obligation bonds. A general obligation bond is a debt instrument that is guaranteed by the taxing and borrowing power of a governmental entity. With general obligation bonds, the governmental entity pays interest and principal that amortizes the entire principal balance of the debt. The phrase full faith and credit refers to any security for which a governmental entity pledges its full taxing and borrowing power, plus any revenue other than taxes that it collects to support payment of debt. For example, the State of Minnesota, when issuing a general obligation bond to incur public debt pledges “[t]he full faith, credit, and taxing powers of the state” to repay the principal and interest of the bond. MINN. STAT. 16A.641 SUBD.1 (2002).

Governmental entities 12 use their full faith and credit to reduce the risk of financial instruments they issue, and hence, reduce the cost of borrowing. Since a governmental entity 12 can bring in future revenue through taxation, the risk that a governmental entity will default on a financial instrument is extremely low, making the financial instrument virtually risk-free. As a result, investors are willing to accept a lower rate of return on a government financial instrument than on a corporate bond from a company with a high-grade bond rating.

In order to minimize the risk to the private entity 16, and hence minimize the cost to the governmental entity 12, the present investment vehicle secured by governmental assets 10 comprises a general obligation lease 22. A “general obligation lease” has the investment risk characteristics of a general obligation bond, but lease payments under the lease are less than the debt service on conventional government securities yielding the same amount of funds obtained through the sale of the governmental asset. In another embodiment, the lease 22 is a conventional government backed lease.

The lease payments 24 on the present general obligation lease 22 only have to amortize the difference between the purchase price of the governmental asset 14 and the residual value of the asset 26 at the end of the lease 22, thus lowering the amount paid by the government versus a conventional government bond. In some embodiments, the present general obligation lease 22 has the characteristics of a Real Estate Bonded Investment Trust (“REBIT”). The general obligation lease 22 is guaranteed by the full faith and credit of the governmental entity 12.

Financial Benefits of the Present Sale and Lease-Back System

In the present sale and lease back system 10, the risk that the governmental entity 12 will default on the lease 22 is essentially the same as the risk of default by the governmental entity 12 on a government security. In order to entice the governmental entity 12 to participate, the lease payments 24 will be a function of the cost of obtaining the same amount of funds 20 through conventional government debt instruments, not the fair market value of leasing a comparable private asset. In practice the lease payments 24 will typically be lower than the cost of obtaining the same amount of money through the issuance of a government security because the present investment vehicles are secured by governmental assets 10 and have at least three significant financial advantages over such government securities.

First, the private entity 16 will realize the benefit of the appreciation on the private asset 26. Since the private entity 16 holds the title 18 to the private asset 26, it is free to sell the private asset 26 at any time, subject to the lease 22 to the governmental entity 12. If the private asset 26 experiences significant appreciation, the private entity 16 is free to cash-out some or all of that appreciation.

Second, at the end of the lease 22 the private entity can lease the private asset 16 to a non-governmental entity at fair market value, which will likely be significantly higher than the lease payments 24 made by the governmental entity 12. Thus, the private entity 16 has an opportunity for a higher return because it can then lease the private asset 26 based on commercially competitive rates.

Third, governmental entities commonly waive property tax obligations on buildings used for governmental purposes. The general obligation lease 22 preferably waives or reduces the property tax obligations on the private asset 26 for some period of time. Since the governmental entity 12 was not previously receiving property taxes on the governmental asset 14, there is no net loss of revenue to the governmental entity 12. The property tax abatement is preferably for at least the term of the lease 22, and more preferably, for the life of the private asset 26.

Other mechanisms are also available to further reduce the cost of the lease payments 24. The governmental entity 12 can waive or reduce income tax liability on the lease payments 24 preferably during the term of the lease 22, and more preferably for the life of the private asset 26. Such a waiver is analogous to the use of tax-free status of municipal bonds to attract investors to lower-yield investments. In yet another embodiment, the Federal government can grant preferential tax treatment for lease payments 24 made in connection with the investment vehicles secured by governmental assets 10 of the present invention. Again, such preferential tax treatment reduces the lease payments 24 made by the governmental entity 12 and/or increases the funds 20 received by the governmental entity 12.

If a particular investor 34 elects to sell the equity instruments 38 or the private entity 16 liquidates some or all of the private asset 26, the investors will typically be subject to the capital gains tax. The lease payments 24 can be further reduced by permitting investors 34 to defer capital gains if the proceeds are reinvested in another sales and lease-back system 10.

With the availability of the present invention, governmental entities will be unwilling to make lease payments 24 greater than the cost of obtaining the same amount of funds 20 through conventional debt instruments, such as issuing bonds. The cost of obtaining the funds 20 will be less than conventional debt instruments and will represent a theoretical cap on what the governmental entity 12 would be willing to pay in lease payments 24. From an investor's point of view, the present investment vehicles secured by governmental assets 10 pays a lower rate of return than a conventional government security, but provides potential appreciation of the private asset 26 that is not available with conventional government securities.

The one exception to this general rule is that as the governmental entity 12 issues more debt instruments, the incremental cost increases. That is, the more debt the governmental entity 12 incurs, the lower the credit rating for that governmental entity, and hence, the greater the cost of issuing debt instruments. Consequently, the lease payments 24 may vary depending on the credit status of the governmental entity 12.

The general obligation lease of the present invention can be structured in a variety of ways. In one embodiment, the general obligation lease 22 is secured by contractual provisions in the lease document that pledge the taxing and borrowing power of a governmental entity to fulfilling the lease payments 24. The contractual provision may also grant the private entity 16 the right to bring actions against the governmental entity 12 in the event of disputes over the lease 22. In still another embodiment, the general obligation lease 22 is structured to comply with statutory provisions that allow the governmental entity 12 to pledge the full faith and credit of the governmental entity 12 to make lease payments to the private entity 16 on the lease 22.

In one embodiment of the general obligation lease 22 is secured and/or paid by an investment vehicle 32 guaranteeing the lease payments 24 under the lease 22 issued in favor of the private entity 16. The investment vehicle 32 guarantees that the governmental entity 12 will use every available means to ensure that it will honor the terms of the lease 22. The investment vehicle 32 is preferably a separate, fully negotiable, financial instrument pledging the full faith and credit of the governmental entity 12 to fulfill its obligations under the lease 22.

In one embodiment, the investment vehicle 32 is a security, such as a general obligation bond, for which the interest payments are in an amount and have due dates that correspond to the lease payments 24 under the lease 22. The interest payments on the investment vehicle 32 are used to make the lease payments 24. For example, the credit instrument 32 can be a general obligation coupon bond that pays the private entity 16 a specified amount of money at given dates until maturity. The given dates and the amounts paid preferably correspond to the due dates and the amounts of the lease payments. The face value of the bond at maturity is typically zero. In this embodiment, general obligation coupon bonds actually pay the lease payments 24 and are freely negotiable by the private entity 16. Since some or all of the coupons can be sold, the general obligation coupon bond embodiment provides the private entity 16 added liquidity.

In another embodiment, the credit instrument 32 can be general obligation zero coupon bonds. Zero coupon bonds are sold at a discount of the face value and mature at the face value. The governmental entity 12 can issue a series of general obligation zero coupon bonds with maturity dates and face values corresponding to the due date and amount of the lease payments 24. Again, the general obligation zero coupon bonds actually pay the lease payments 24 and are freely negotiable by the private entity 16. Under U.S. tax law, the imputed interest on a zero-coupon bond is taxable as it accrues, even though there is no cash flow. In order to make this embodiment more attractive to investors, the tax code will preferably be modified to exempt the imputed interest from tax liability until such bonds are redeemed.

The general obligation lease 22 and/or the investment vehicle 32 preferably allow either the private entity 16 or the governmental entity 12 to transfer all or part of their interest in the private asset 26. For example, the governmental entity 12 may have a lease for the entire private asset 26. As the needs of the governmental entity 12 fluctuate, it may wish to utilize only a portion of the building for its own uses and sublease or assign a portion of its lease 22 obligations in the private asset 26 to a third party. In such an instance, the investment vehicle 32 may allow the governmental entity to engage in such activity, and provide a means for the governmental entity 12 to collect rent from the sublease or assignment. In the preferred embodiment, the full faith and credit of the governmental entity 12 backs the lease payments from the sublessee.

Further, it is possible, but not necessary, that the investment vehicle 32 may provide a means for the private entity 16 to share in any increased revenue that may be generated as a result of the sublease or assignment. In exchange, it is possible that the investment vehicle 32 may provide that the governmental entity 12 need only apply the full faith and credit for a portion of the lease payments 24 or duration of the lease.

The investment vehicle 32 also preferably permits the private entity 16 to transfer all or part of its rights in the private asset 26 and/or the lease 22 to a third party. For example, the private entity 16 may want to transfer the rights to some or all of the future lease payments 24 to a third party in exchange for a lump sum payment. In addition, the private entity 16 may want to sell its remainder interest in the private asset 26. The investment vehicle 32 may allow the private entity 16 to engage in some or all types of rights transfers, while pledging the full faith and credit of the governmental entity 12 to the lease payments 24.

In another embodiment, the portion of the private asset 26 leased by the governmental entity 12 may fluctuate over the life of the lease 22. The investment vehicle 32 can be structured to permit this fluctuation, while maintaining the full faith and credit guarantee on the lease payments 24.

It can be seen that a general obligation lease like the one described above would provide governmental entities 12 an opportunity to exploit the equity it has in various governmental assets 14. The general obligation lease 22 allows governmental entity 12 to retire debts, to provide services, and to reduce its illiquid assets without increasing the cost of obtaining capital. The general obligation lease 22 also allows a governmental entity to reduce the risk a potential investor may assume in a typical sale and lease-back arrangement, thereby allowing the governmental entity to lease the properties back at lower lease rates, while still providing an attractive investment alternative for private entities.

During times when interest rates are low, the lease payments 24 operate as a guaranteed stream of income to the private entity 16. During times of high interest rates, the appreciation of the underlying private asset 26 off-sets, at least in part, the opportunity cost of lease payments 24 that pay a return lower than prevailing rates. Thus, the present investment vehicles secured by governmental assets 10 provides a competitive return in a variety of market conditions with minimal risk.

Government as General or Managing Partner

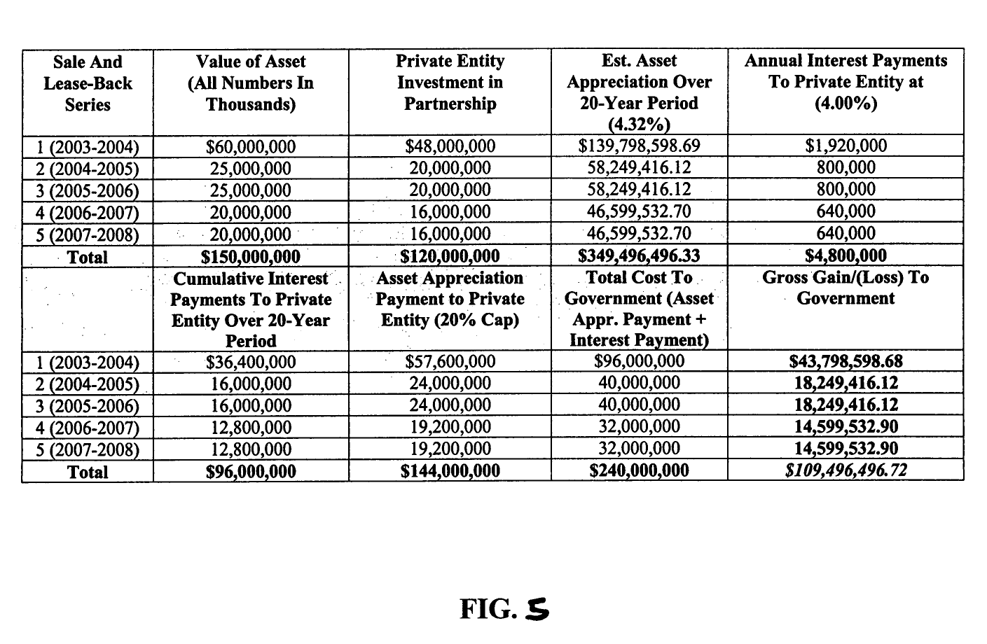

An alternate embodiment of the present invention is schematically illustrated in FIG. 4. In the investment vehicles secured by governmental assets 110 of this embodiment, title 118 of governmental asset 114 is transferred to a private entity 116 that is preferably a partnership. The governmental entity 112 and one or more investors 134 are the partners. The governmental asset 114 is transferred to the partnership 116. The governmental entity 112 receives funds 120 and lease 122. In return, the governmental entity makes lease payments 124 to the partnership 116. A lease agreement 122 governs the terms of the lease and the arrangement is secured by an investment vehicle 132. The investors 134 are generally private entities that invest funds 136 in the partnership 116 in exchange for a partial interest 138 in the partnership 116. The governmental entity 112 may have a controlling interest in the partnership 116 such that control of the private asset 126 essentially remains with the governmental entity 112.

In the preferred embodiment, the partnership 116 is a limited partnership, in which the governmental entity 112 is a general partner, and the one or more investors 134 are limited partners. The governmental entity contributes title to the governmental asset 114 to the partnership 116. The investors contribute funds 136 to the partnership 116. The partnership 116 uses the funds 120 from the investors 134 to pay the governmental entity 112 for some portion of the asset 114. For example, the funds 120 may equal 80% of the appraised value of the governmental asset 114. In this example, the governmental entity 112 would own 20% in the partnership 116 and be the general partner. In another embodiment, the funds 120 are less than 50% of the appraised value of the governmental asset 114. The governmental entity 112 owns more than 50% in the partnership 116 and is the general partner. Since the governmental entity 112 is the general partner, the private asset 126 is preferably exempt from property taxes.

The partnership 116 grants the governmental entity 112 a lease 122 to some or all of the private asset 126. The lease 122 can be a general obligation lease or a conventional government backed lease. A conventional government backed lease preferably has the characteristics of revenue bond type payments with appropriate governmental guarantees. Preferably, the governmental entity 112 guarantees the principle investments 136 made by the investors 134.

The lease 122 requires the governmental entity 112 to make periodic payments 124 to the partnership 116. These payments 124 can be characterized as lease payments, interest payments or some allocation of lease and interest payments. In the preferred embodiment, the payments 124 are primarily characterized as interest payments to investors, similar to tax free government bonds. The partnership 116 distributes the payments 124 to the investors 134 in proportion to their respective interests 138.

At the end of the lease 122 the private asset 126 is appraised. The investment vehicle 132 provides the general partner, the governmental entity 112, with a number of options.

First, the governmental entity 112 buys back the private asset 126 from the partnership 116. The investors 134 receive their principle investments 136 and some portion of the appreciation, if any, as determined by the appraisal. The investment vehicle 132 preferably provides a formula for calculating the value of the private asset 126. For example, participation in any appreciation by the investors 134 can be capped at 20% of their initial investment of funds 136. The formula preferably provides that the investors 134 receive at least their initial capital contribution. If the appraisal of the private asset 126 indicates a decrease in value, the governmental entity 112 is required to make up the difference.

Second, the partnership 116 sells the private asset 126. Again, the investors 134 receive their principle investments 136 and some portion of the appreciation, if any, as determined by the appraisal. The governmental entity 112 preferably guarantees that the investors 134 will receive at least their initial capital contribution. If the sale of the private asset 126 generates insufficient funds to pay the investors 134 their capital contribution, the governmental entity 112 is required to make up the difference.

Third, the governmental entity 112 wants to retain ownership of the private asset 126, but does not have the funds to buy it back from the partnership 116. The governmental entity 112 has the option to form a new private entity to raise the capital to buy out the prior partnership 116.

Fourth, the governmental entity 112 sells its ownership interest in the private asset 126 to the partnership 116. Again, the investment vehicle 132 preferably provides a formula for calculating the price of the private asset 126.

In this manner, the governmental entity 112 controls the disposition of the private asset 126, while the investors 134 receive lease and/or interest payments 124, and some portion of any final payout for the appreciation of the private asset 126. The portion of appreciation received by the limited partners 134 is optionally capped at a particular level, allowing the general partner 112, in this case the government entity, to realize a greater percentage of the appreciation in the private asset 126.

The value of each of the investor's 134 ownership in the private asset 126 is preferably limited to a percentage of that investor's 134 initial investment in the partnership 116. In this manner, the governmental entity 112 may realize an increased gain from appreciation in the private asset 126, which may result in a gross gain to the governmental entity 112 over the term of the lease. Thus, the sale/lease back agreement may be an even more beneficial source of funds than conventional debt or equity instruments for the governmental entity 112.

In yet another embodiment, the private entity 116 is a corporation that issues common stock 138 to the investors 134 and preferred stock 140 to the governmental entity 112. Again, the governmental entity 112 retains control of the private asset 126 and optionally receives a larger portion of any appreciation in the private asset 126 upon liquidation or at the end of the lease 122.

The private entity 116 can be dissolved at a time and under conditions specified in the partnership agreement and in accordance with applicable state law. Once the private entity 116 is dissolved, the private asset 126 may be reorganized in a new private entity for the generation of new non-tax revenues. When the private entity 116 ends, the private asset 126 is reappraised. Normally the property will show substantial appreciation. The value of the investors' 134 investment may be a predetermined percentage of the appreciation, but can optionally be capped at a percentage of the initial investment. The general partner, in this case the governmental entity 112, captures the remaining appreciation. Thus, the investors 134 not only receive a guaranteed annual return, but also have the potential for principle appreciation. The general partner reserves the majority of the appreciation potential for future usage.

Government Retains Title to the Governmental Asset

In another embodiment of the present invention, title 118 of governmental asset 114 is retained by the governmental entity 112. There is no conversion of the governmental asset 114 into a private asset 126. The governmental entity 112 receives capital contribution or funds 120 from the private entity 116. The amount of the funds 120 is preferably capped at some percentage of the appraised value of the governmental asset 114, such as for example, 80% of the appraised value of the governmental asset 114.

In return for the funds 120, the governmental entity 112 issues the investment vehicle 132 to the private entity 116. The investment vehicle 132 has a term (e.g., 20 years) and a face value equal to the funds 120 provided to the governmental entity 112. The investment vehicle 132 includes a guarantee from the governmental entity 112 to repay the funds 120 at the end of the term. The investment vehicle 132 requires the governmental entity 112 to makes periodic payments 124 to the private entity 116 and to pledge the governmental asset 114 as security for the investment vehicle 132. The investment vehicle 132 provides for participation at the end of the term in any appreciation in the governmental asset 114 by the private entity 116. The participation by the private entity 116 is typically capped at some pre-determined percentage of the appreciation.

The investment vehicle 132 preferably resembles a bond. In one embodiment, the investment vehicle 132 is a certificate of participation (COP) bond. The governmental asset 114 is optionally a pool of a plurality of governmental assets 112. Consequently, the investment vehicle 132 is secured by all of the governmental assets 114 in the pool. The investment vehicle 132 can optionally be recorded as a lien against the governmental asset 114. The investment vehicle 132 is preferably non-callable.

The investment vehicle 132 requires the governmental entity 112 to make periodic payments 124 to the private entity 116 for a specified period of time. The periodic payments 124 are preferably a fixed percentage (e.g., 4%, 5%, etc.) of the capital contribution 120 paid to the governmental entity 112. In the preferred embodiment, the periodic payments 124 are primarily characterized as interest payments to investors, similar to tax-free government bonds. The private entity 116 distributes the periodic payments 124 to the investors 134 in proportion to their respective investment 136.

At the end of the term of the investment vehicle 132 (e.g., when the investment vehicle 132 matures), the governmental asset 114 is re-appraised. The investment vehicle 132 provides the governmental entity 112 with several options.

In the first option, the governmental entity 112 can repay the private entity 116 the capital contribution 120. In the preferred embodiment, the private entity 116 also receives some portion of the appreciation of the governmental asset 114 during the term of the investment vehicle 132, if any, as determined by the appraisal. The investment vehicle 132 preferably provides a formula for calculating the value of the governmental asset 114. Participation in any appreciation by the investors 134 is typically capped, such as for example at 20% of the capital contribution 120 originally paid to the governmental entity 112 or 20% of the appreciated value of the governmental asset 114. The investment vehicle 132 preferably provides that the private entity 116 receives at least an amount equal to the principal 120, regardless of the appraised value of the governmental asset 114.

In the second option, the governmental entity 112 can sell the governmental asset 114. Again, the private entity 116 receive its capital contribution 120 and some portion of the appreciation, if any, as determined by the appraisal and/or the sale price of the asset 114. The governmental entity 112 preferably guarantees that the investors 134 will receive at least their initial capital contribution 120. If the sale of the private asset 126 generates insufficient funds to pay the investors 134 their capital contribution, the investment vehicle 132 preferably requires the governmental entity 112 to make up the difference.

In the third option, the governmental entity 112 lacks the funds to pay the investors 134 their capital contribution 120. The governmental entity 112 forms a new private entity to raise new capital and uses the funds received to pay off the previous private entity 116.

The present investment vehicle secured by governmental assets 110 is essentially a tax-free, interest paying, non-callable bond, which is secured by one or more governmental assets 114. Upon maturity, the effective interest rate can be increase the appreciation of the governmental asset 114, typically up to some predetermined maximum percentage of the initial investment or percentage of the appreciation. Consequently, the present government backed investment vehicle 110 provides all of the investment benefits of a government bond, with the additional guarantee of specific governmental assets securing the investment 120 and the prospect of additional return on the investment 120 tied to appreciation of the governmental asset 114 during the term of the security instrument 132.

Computerization of the Present Investment Vehicle

In one embodiment, the present sale and lease-back system and method may include a general or special purpose computer programmed to calculate the lease payment 24. As previously noted, the value of the lease payment 24 made by the governmental entity 12 to the private entity 16 may be a function of one or more variables, including the value of the funds 20 paid to the governmental entity 12 and the interest rate costs of those funds. Additional variables may include the risk of default by the governmental entity 12, the expected appreciation of the governmental asset 16, the debt service on an equally-valued conventional security, the terms of the transfer of the governmental asset 14, as well as any tax implications of the arrangement with the governmental entity 12.

In a particular embodiment, the present invention may utilize a computer system to calculate the lease payment 24 as a function of one or more of these variables. In one example, the lease payment 24 may be a function of the value of the funds 20 transferred and the interest rate costs of those funds 20. In another example, the lease payment 24 may be lowered due to a high expectation of asset appreciation or favorable tax treatment. In yet another example, the lease payment 24 may be raised due to restrictions on transfers of the private asset 26 by the private entity 16. Most likely, the lease payment calculation will be a function of many variables, which will differ based on the nature of the agreement between the governmental entity 12 and the private entity 16. Conventional computer systems capable of performing the required algorithm are suitable for use in embodiments of the present invention.

Further embodiments of the present invention may include a system adapted to calculate the expected or actual performance of the sale and lease-back agreement (or a series of agreements) over the period of the lease(s). The expected or actual performance may be calculated as a function of one or more variables, including the expected or actual appreciation of the governmental asset 14 and the interest rate value of the funds 20 transferred to the governmental entity 12. The system may also compare expected and actual results after performance of the agreement. This system may include a computer system capable of performing the necessary calculations. Conventional spreadsheet software may be utilized in this embodiment.

Computer systems may also be used in other aspects of the sale and lease-back system and method of the present invention. For example, a computer system may be used to monitor the receipt of lease payments 24 from the governmental entity 12, and the payment of dividends or other profits to investors 34. Additionally, a computer system may be used to calculate the value of the governmental asset 14 and/or to estimate the appreciation of the private asset 26. Further, a computer system may be used to store and generate various databases of information, for example, information related to participating investors, the governmental assets 114 included in the agreement, the funds to be transferred, the lease terms, the sale document, etc. Such information may be manipulated using the computer system and generated into reports and other printed documents to further implement and administer the system of the present invention.

FIG. 5 illustrates an example of a print-out of the expected results of a series of sale and lease-back agreements calculated by a computer system using conventional spreadsheet software. The data inputted into the spreadsheet (all values in thousands) include the value of the governmental asset 114, the investment value of the one or more investors 134, and the estimated appreciation over the 20-year lease period for each agreement at an estimated 4.32% compounded annually. Based on these variables, the computer system calculates the total interest payments to the investors 134, the asset appreciation payments to the investors 134, the total cost to the government (interest payment+asset appreciation payment) and the relative gain or loss to the governmental entity 112 as a function of the governmental entity's 112 share of the asset appreciation less the total cost to the governmental entity 112. Furthermore, the computer system calculates the total gain or loss to the governmental entity 112 for a series of agreements commenced over 5 consecutive years.

In this example, the investors 134 are limited partners, and are limited to payment of 20% of the appreciation of the private asset 126. The governmental entity 112 retains the remaining 80% of the appreciation. Under this scenario, the governmental entity 112 actually realizes a gross gain over the 20 years of each agreement, as well as a total gain for the series of agreements.

The print-out may be used to demonstrate to the governmental entity 112 that the sale and lease-back system provides the governmental entity 112 with immediate funds, as well as a gross gain at the end of the lease period due to expected property appreciation. The computer system may also be used to calculate actual results and to compare expected and actual results. Such computer output will provide both the governmental entity 112 and the private entity 116 with the data necessary to determine the economic viability of moving forward with the agreement. Although this Example is directed to one embodiment of the present invention, similar spreadsheet models may be used for any of the embodiments reported herein.

Although the present invention has been described with reference to preferred embodiments, workers skilled in the art will recognize that changes may be made in form and detail without departing from the spirit and scope of the invention. In addition, the invention is not to be taken as limited to all of the details thereof as modifications and variations thereof may be made without departing from the spirit or scope of the invention.

1. A computer system for trading investment vehicles secured by governmental assets via a computerized network, the system comprising:
a computer server accessible with a network access device via a communications network;
executable software stored on the server and executable on demand, the software operative with the server to cause the system to:
transmit data relating to trading investment vehicles secured by governmental assets;
receive an instruction to buy or sell an investment vehicle secured by governmental assets;
transmit a live order from an investor, wherein the live order is related to the instruction to buy or sell an investment vehicle secured by governmental assets; and
a database of investment vehicle profiles comprising a term, a face value, a governmental guarantee to repay the face value at the end of the term, a payment schedule requiring periodic payments by the governmental entity comprising a percentage of the face value, and an allocation of appreciation of the pool of governmental assets during the term of the investment vehicle.

2. The computer communications system of claim 1 wherein the communication network comprises private network.

3. The computer communications system of claim 1 wherein the communication network comprises the Internet.

4. A method of trading investment vehicles secured by governmental assets via a computerized network, the system comprising the steps of:
establishing a computer server accessible with a network access device via a communications network;
executing software stored on the server;
transmitting data relating to trading investment vehicles secured by governmental assets;
receiving an instruction to buy or sell an investment vehicle secured by governmental assets;
transmitting a live order from an investor, wherein the live order is related to the instruction to buy or sell an investment vehicle secured by governmental assets; and
maintaining a database of investment vehicle profiles comprising a term, a face value, a governmental guarantee to repay the face value at the end of the term, a payment schedule requiring periodic payments by the governmental entity comprising a percentage of the face value, and an allocation of appreciation of the pool of governmental assets during the term of the investment vehicle.

5. An investment vehicle secured by governmental assets comprising:
one or more governmental assets comprising a pool of governmental assets;
an investment vehicle secured by the pool of governmental assets, the investment vehicle comprising;
a term;
a face value that is less than, or equal to, an appraised value of the pool of governmental assets;
a governmental guarantee to repay the face value at the end of the term;
a payment schedule requiring periodic payments by the governmental entity comprising a percentage of the face value; and
an allocation of appreciation of the pool of governmental assets during the term of the investment vehicle.

6. The system of claim 5 wherein the allocation of appreciation of the pool of governmental assets comprises a maximum percentage of the appreciation.

7. The system of claim 5 wherein the allocation of appreciation of the pool of governmental assets comprises a maximum percentage of the face value.

8. The system of claim 5 wherein the periodic payments are tax-free interest payments.

9. The system of claim 5 wherein the investment vehicle comprises a plurality of zero coupon bonds with maturity dates and face values that correspond to the periodic payments.

10. The system of claim 5 wherein the investment vehicle comprises a plurality of coupon bonds, wherein the coupons have maturity dates and face values that correspond to the periodic payments.

11. The system of claim 5 wherein the periodic payments are less than debt service on a conventional government security yielding the face value of the investment vehicles secured by governmental assets.

12. The system of claim 5 comprising:
a private entity that purchases the investment vehicles secured by governmental assets; and
equity instruments issued by the private entity to investors that contribute funds to the private entity.

13. An investment vehicle secured by governmental assets comprising:
a sales document transferring title of a governmental asset to a private entity in exchange for funds, the transfer of title converting the governmental asset into a private asset; and
an investment vehicle comprising a general obligation lease between the private entity and the governmental entity granting the governmental entity usage of at least a portion of the private asset in exchange for periodic payments.

14. The system of claim 13 wherein the periodic payments comprises one or more of lease payments, interest payments, or a combination thereof.

15. The system of claim 13 wherein the investment vehicle pledges the full faith and credit of the governmental entity to make periodic payments to the private entity.

16. The system of claim 13 wherein the investment vehicle comprises a plurality of zero coupon bonds with maturity dates and face values that correspond to the payments.

17. The system of claim 13 wherein the investment vehicle comprises a plurality of coupon bonds, wherein the coupons have maturity dates and face values that correspond to the payments.

18. The system of claim 13 wherein the general obligation lease permits the private entity to transfer all or part of its rights in the private asset to a third party.

19. The system of claim 13 wherein the periodic payments are determined by the interest rate costs of the funds instead of the fair market value of the governmental asset.

20. The system of claim 13 wherein the periodic payments under the lease are less than debt service on a conventional government security yielding the same amount of finds obtained through the sale of the governmental asset.

21. The system of claim 13 wherein the funds are greater than or less than the fair market value of the governmental asset.

22. The system of claim 13 comprising a tax abatement agreement on the private asset during a term of the general obligation lease.

23. The system of claim 13 comprising an agreement to waive or reduce tax liability on the periodic payments.

24. The system of claim 13 comprising at least one class of equity instruments issued by the private entity to investors that contribute funds to the private entity.

25. The system of claim 13 wherein the investors receive a portion of any appreciation of the private asset at the end of the lease.

26. The system of claim 13 wherein a portion of the funds used to purchase the governmental asset are derived from granting a mortgage in the private asset to a lender.

27. The system of claim 13 wherein investors in the private entity include the governmental entity.

28. The system of claim 13 wherein the governmental entity has a controlling interest in the private entity.

29. The system of claim 13 wherein the private entity comprises a partnership, and wherein the governmental entity is a general partner and the private investors are limited partners.

30. An investment vehicle secured by governmental assets comprising:
a sales document transferring title of a governmental asset to a private entity in exchange for funds, the transfer of title converting the governmental asset into a private asset; and
a general obligation lease between the private entity and the governmental entity granting the governmental entity usage of at least a portion of the private asset in exchange for payments, wherein the general obligation lease comprises the investment risk characteristics of a general obligation bond, but payments under the lease are less than the debt service on conventional government securities yielding the same amount of funds obtained through the sale of the governmental asset.

31. A method of operating an investment vehicle secured by governmental assets comprising the steps of:
pooling one or more governmental assets;
appraising the value of the pool of governmental assets;
establishing a term for the investment vehicle;
establishing a face value for the investment vehicle that is less than, or equal to, an appraised value of the pool of governmental assets;
receiving funds from the investor corresponding to the face value of the investment vehicle;
issuing to at least one investor an investment vehicle secured by the pool of governmental assets;
providing a governmental guarantee to repay to the investor the face value at the end of the term;
establishing a payment schedule of periodic payments by the governmental entity to the investor comprising a percentage of the face value; and
allocating to the investor at least a portion of appreciation of the pool of governmental assets during the term of the investment vehicle.

32. The method of claim 31 wherein the step of allocating the appreciation of the pool of governmental assets comprises establishing a maximum percentage of the appreciation.

33. The method of claim 31 wherein the step of allocating the appreciation of the pool of governmental assets comprises establishing a maximum percentage of the face value.

34. The method of claim 31 wherein the periodic payments comprise tax-free interest payments.

35. The method of claim 31 wherein the investment vehicle comprises a plurality of zero coupon bonds with maturity dates and face values that correspond to the periodic payments.

36. The method of claim 31 wherein the investment vehicle comprises a plurality of coupon bonds, wherein the coupons have maturity dates and face values that correspond to the periodic payments.

37. The method of claim 31 wherein the investor comprises one or more private entities that issue equity instruments to investors that contribute funds to the private entity.

38. A method of operating an investment vehicle secured by governmental assets comprising the steps of:
transferring title of a governmental asset to a private entity in exchange for funds, the transfer of title converting the governmental asset into a private asset; and
issuing an investment vehicle comprising a general obligation lease between the private entity and the governmental entity granting the governmental entity usage of at least a portion of the private asset in exchange for periodic payments.

39. The method of claim 38 comprising issuing an investment vehicle having a plurality of zero coupon bonds with maturity dates and face values that correspond to the periodic payments.

40. The method of claim 38 comprising issuing an investment vehicle having a plurality of coupon bonds, wherein the coupons have maturity dates and face values that correspond to the periodic payments.

41. The method of claim 38 comprising the step of granting a property tax abatement on the private asset during a term of the general obligation lease.

42. The method of claim 38 comprising the step of waiving tax liability on the periodic payments during a term of the general obligation lease.

43. The method of claim 38 comprising the private entity issuing at least one class of equity instruments to investors that invest funds to the private entity.

44. The method of claim 38 comprising obtaining a portion of the funds used to purchase the governmental asset by granting a mortgage in the private asset to a lender.

45. The method of claim 32 wherein the private entity comprises a partnership, and wherein the governmental entity is a general partner and private investors are limited partners.

46. A method of operating an investment vehicle secured by governmental assets comprising the steps of:
transferring title of a governmental asset to a partnership in exchange for funds, the transfer of title converting the governmental asset into a private asset; and
executing a general obligation lease between the partnership and the governmental entity granting the governmental entity usage of at least a portion of the private asset in exchange for payments,
wherein the partnership comprises the government entity and at least one investor as partners.
